(19) United States
(12) Patent Application Publication
(10) Pub. No.: US 2024/0033851 A1
(43) Pub. Date: Feb. 1, 2024

(54) APPARATUS AND METHOD FOR POLARIZING A LASER BEAM HAVING AN UNDEFINED POLARIZATION STATE AND LASER MACHINING SYSTEM

(71) Applicant: TRUMPF Werkzeugmaschinen SE + Co. KG, Ditzingen (DE)

(72) Inventors: Thomas Lehleiter, Stuttgart (DE); Christian Schmittner, Bessenbach (DE)

(21) Appl. No.: 18/483,656

(22) Filed: Oct. 10, 2023

Related U.S. Application Data
(63) Continuation of application No. PCT/EP2022/058324, filed on Mar. 29, 2022.

(30) Foreign Application Priority Data
Apr. 8, 2021 (DE) 10 2021 108 759.7

(51) Int. Cl. B23K 26/073; B23K 26/03; B23K 26/064

(52) U.S. Cl. CPC B23K 26/0738; B23K 26/032; B23K 26/064

(57) ABSTRACT

An apparatus for polarizing an input laser beam having an undefined polarization state includes a beam splitting device for splitting the input laser beam into a first component beam having a first defined polarization state and a second component beam having a second defined polarization state. A polarization changing element changes the polarization state of one of the polarized component beams, with the result that both component beams have the same defined polarization state. A focusing element is configured to input couple both component beams into a light-guiding element in order to combine the component beams to form an output laser beam while maintaining the defined polarization state. A laser machining system including the apparatus and a method for polarizing an unpolarized laser beam, are also provided.

### CROSS-REFERENCE TO RELATED APPLICATION

This application is a continuation, under 35 U.S.C. § 120, of copending International Patent Application PCT/EP2022/058324, filed Mar. 29, 2022, which designated the United States; this application also claims the priority, under 35 U.S.C. § 119, of German Patent Application DE 10 2021 108 759.7, filed Apr. 8, 2021; the prior applications are herewith incorporated by reference in their entirety.

### FIELD AND BACKGROUND OF THE INVENTION

The invention relates to the field of laser machining. In particular, the invention relates to an apparatus and a method for polarizing a laser beam, and a laser machining system including the apparatus.

When material is machined by using a laser beam, the polarization of the laser beam plays an important role. A defined polarization state of the laser beam allows certain interactions between laser beam and workpiece to be exploited in a targeted manner, for example in order to optimize the energy input into the workpiece by way of an adapted (e.g., increased) absorption of the laser radiation.

The majority of work currently undertaken within the scope of material machining by way of solid state lasers makes use of unpolarized radiation. This is due to the fact that, inter alia, the transportation fibers which guide the raw laser beam from the laser source to the machining optical unit and which typically have lengths of at least 20 m are unable to transfer a defined polarization state.

Although the polarization of a laser beam in the machining optical unit of a laser machining system may be unpolarized or randomly polarized, that is generally connected to a significant loss of energy. For example, a laser beam without a defined polarization state can be split into two polarized component beams by using a beam splitter. Since it is not readily possible to combine the two component beams to form a polarized machining beam (or output laser beam), only one of the component beams is used as a working beam. Thus, approximately 50% of the energy of the input laser beam is lost.

Chinese Publication CN 1484065 A describes an apparatus in which an incident unpolarized light beam is split into two differently polarized component beams, which are recombined by using optical elements. The incident light beam is split by using a birefringent element. The polarization state of one of the component beams is rotated by using a waveplate, with the result that both component beams have the same polarization state. The two component beams are then recombined via a lens and a K-shaped prism.

A substantial disadvantage of that apparatus lies in the fact that the resultant output beam does not have a defined, homogenous beam profile. Basically, the two component beams continue to exist in a spatially adjacent or partially overlapping manner, without “mixing” to form a common output beam.

### SUMMARY OF THE INVENTION

It is accordingly an object of the invention to provide an apparatus and a method for polarizing a laser beam having an undefined polarization state and a laser machining system, which overcome the hereinafore-mentioned disadvantages of the heretofore-known apparatuses, methods and systems of this general type and which render it possible to modify an input laser beam having no defined polarization state, in such a way, without loss of power, that the input laser beam has a defined polarization state.

With the foregoing and other objects in view there is provided, in accordance with the invention, an apparatus for polarizing an input laser beam according to one aspect, with the input laser beam having an undefined polarization state. The apparatus includes a beam splitter device which is configured to split the input laser beam into a first component beam having a first defined polarization state and into a second component beam having a second defined polarization state. Further, the apparatus includes a polarization changing element for changing the polarization state of one of the polarized component beams, with the result that both component beams have the same defined polarization state. The apparatus includes a focusing element and a light-guiding element. The focusing element is configured to input couple both component beams into the light-guiding element in order to combine the component beams (by using the light-guiding element) to form an output laser beam while maintaining the defined polarization state (of the component beams).

The designations “input laser beam,” “first component beam,” “second component beam,” and “output laser beam” can preferably relate to different states of the same laser beam at different points in the beam path of the laser beam. The different designations in this respect merely serve to distinguish the various states or properties of the laser beam prior to or after the passage through the apparatus according to the invention.

Surprisingly, it was established that the component beams mix substantially without losses in the polarization state of the component beams to form a common laser beam (output laser beam) when passing through the light-guiding element, which is preferably configured as a fiber length. Consequently, a laser beam having an undefined polarization state can be polarized substantially without loss of power by using the apparatus disclosed hereinabove.

Examples of laser beams which have an undefined polarization state include unpolarized or randomly polarized laser beams, for which the polarization state is unknown.

It is understood that the components of the apparatus are preferably disposed successively in the described order in the propagation direction of the input laser beam.

It is also understood that the input laser beam or the component beams must be suitable for beam transmission by using optical waveguides (such as the light-guiding element). In particular, the input laser beam can be a solid-state laser beam. The laser beam (i.e., as input laser beam, and as the component beams, and as output laser beam) may have for example a wavelength of between 200 nm and 1300 nm, for example 515 nm or 1030 nm.

The input laser beam can preferably be directed in a collimated state at the beam splitting device. Alternatively, the input laser beam may also run slightly divergently or slightly convergently. For the purpose of providing a collimated input laser beam, it is possible to provide a collimation device (e.g., in the form of a lens or a mirror) which collimates the input laser beam prior to entry into the apparatus according to the invention.

Maintaining the polarization state of the component beams in the output laser beam should be understood to mean that the majority (i.e., at least 50%) of the output laser beam has the defined polarization state of the component beams, or a defined (e.g., slightly rotated) polarization state which deviates slightly from the aforementioned defined polarization state. According to a preferred variant, the proportion of the defined polarization state in the output laser beam can be at least 90%, preferably at least 95%, more preferably at least 98%. By way of example, the polarization state of a (fully) s-polarized component beam in the output laser beam should be considered maintained if the output laser beam still is 98% s-polarized.

For the purpose of the present invention, the correspondence of the polarization state of the output laser beam with the defined polarization state of the component beams can be determined in particular on the basis of the degree of polarization of the output laser beam. Here, the assumption can be made that the degree of polarization (P) of the component beams is P=1. The degree of polarization can be determined on the basis of the Stokes parameter, for example as described in Edward Collett (2005), Field Guide to Polarization, SPIE Press, p. 39 ff.

The light-guiding element preferably has a length long enough to combine the two component beams to form an output laser beam within the light-guiding element and/or short enough to maintain the defined polarization state of the two component beams in the output laser beam.

The combination of the component laser beams to form the output laser beam can be understood as a mixing of the component laser beams when passing through the light-guiding element, with the result that the output laser beam preferably has a uniform intensity distribution along its circumference. The output laser beam may have different cross-sectional shapes depending on the geometry of the light-guiding element. By way of example, the output laser beam may have a radially symmetric beam profile when an optical fiber with a circular cross section is used. The output laser beam may also have a polygonal, for example rectangular, or elliptical beam profile if a polygonal, for example rectangular, or elliptical fiber length is used. For example, an output laser beam with a defined polarization state can easily be rotated by using a waveplate, with the result that the polarization direction can be adapted to an advancement direction during the material machining.

Preferably, the beam splitting device can further be configured to deflect the first component beam and/or the second component beam in such a way that the two component beams run substantially parallel to one another. In this case, the phrase “substantially parallel” should be understood as including a deviation from the exact parallel position for as long as the two component beams are able to be input coupled into the light-guiding element by using the focusing element. By way of example, the phrase may include a deviation of up to 2°.

According to one variant, the length of the light-guiding element might be no more than 500 mm, preferably no more than 100 mm, more preferably no more than 50 mm.

In some fields of application, it may further be advantageous for the light-guiding element to have a length of one meter or a few meters. What needs to be taken into account in this context is that the defined polarization state of the component beams in the output laser beam is gradually lost with increasing length of the light-guiding element. The shorter the light-guiding element, the better the defined polarization state of the component beams is maintained in the output laser beam. By way of example, the polarization state of the output laser beam may still correspond to approximately 98% of the defined polarization state of the component beams when the light-guiding element has a length of 50 mm. This value may still be above 90% when the light-guiding element is a length of 1 m. It is therefore understood that the advantageous effects of the present invention—albeit in weakened form—still clearly come into effect when using a light-guiding element with a length of a few meters (e.g., up to 10 m).

Further, the length of the light-guiding element can be at least 15 mm, preferably at least 20 mm. Depending on the light-guiding element used, a specifiable minimum length of the light-guiding element is required to ensure a homogeneous beam profile of the output laser beam, in particular with a uniform intensity distribution along the circumference of the output laser beam.

Thus, it may overall be advantageous if the length of the light-guiding element is as short as possible in order to maintain the defined polarization state of the two component beams in the output laser beam to the greatest possible extent and is as long as necessary to ensure a sufficient homogeneity of the output laser beam.

The focusing element and the light-guiding element may be disposed symmetrically in the beam path of the component beams, to such an extent that the component beams are input coupled into the light-guiding element at the same angle.

In other words, the focusing element and the optical fiber can both be disposed on a central axis in the beam path which runs centrally between and parallel to the component beams. A ring-shaped beam profile arises in the far field of the output laser beam if both component beams are input coupled into the light-guiding element at the same angle.

According to an alternative variant, the focusing element and the light-guiding element may be disposed asymmetrically in the beam path of the component beams, to such an extent that the component beams are input coupled into the light-guiding element at different angles.

In this variant, the focusing element and the light-guiding element may have an axial offset from the central axis. In the case of a maximum offset, the focusing element and the light-guiding element can be located on the beam axis of one of the component beams, with the result that this component beam is input coupled into the light-guiding element at right angles. The other component beam is accordingly input coupled into the light-guiding element at a comparatively acute angle. Such maximal asymmetry of the input coupling of the two component beams into the light-guiding element yields a beam profile with a central spot and an outer ring in the far field of the focused output laser beam. It is understood that further asymmetric arrangements of the focusing element and the light-guiding element are possible between the symmetric arrangement and the maximally asymmetric arrangement, and cause corresponding beam profiles.

It is further understood that the angle of incidence of the component beams into the light-guiding element can additionally be regulated by the spacing between the component beams and the distance between the focusing element and optical fiber.

Thus, to regulate the beam profile of the output laser beam, provision can be made for the focusing element and the light-guiding element to be displaceably disposed along and/or across the beam propagation direction of the component beams.

According to a variant, the beam splitting device may include a thin-film polarizer and a mirror. The thin-film polarizer can be disposed at an angle in the beam path of the input laser beam such that a first component of the input laser beam, which has the first defined polarization state, is transmitted through the thin-film polarizer as first component beam and a second component of the input laser beam, which has the second defined polarization state, is reflected at the surface of the thin-film polarizer as second component beam. The mirror can be disposed at an angle in the beam path of one of the component beams in order to reflect the incident component beam in such a way that the latter is aligned substantially parallel to the other component beam.

The use of thin-film polarizers is particularly suitable for high laser powers.

It is understood that a separate mirror may also be disposed in each of the component beams, the respective mirror reflecting or deflecting the respective component beam in such a way that the component beams run substantially parallel to one another.

The use of a thin-film polarizer and a mirror for the beam splitting device has the advantage that the spatial distance between the component beams can be set as desired, independently of the laser power of the input laser beam.

According to an alternative variant, the beam splitting device can be a birefringent optical element which has different refractive indices in relation to the first defined polarization state and the second defined polarization state, with the result that the input laser beam is split into the first and the second component beam upon incidence in the birefringent element, with the component beams being aligned (substantially) parallel to one another by refraction effects upon the exit from the birefringent element.

The structure of this variant is particularly simple. Then again, the spatial offset of the component beams depends directly on the thickness of the birefringent element and cannot readily be set as desired.

The polarization changing element can be a waveplate, in particular a half-wave plate. In this way, the polarization state of the incident component beam can be rotated through 90°.

The purpose of changing the polarization of at least one of the component beams lies in aligning the (defined) polarization states of the component beams. It is understood that a multiplicity of possible combinations as to how the polarization states of the component beams can be aligned to one another arise in the process. A simple example would include the input laser beam being split into two linearly polarized component beams, with the first component beam having a p-polarization and the second component beam having an s-polarization. The polarization direction of one of the component beams can then be rotated, for example by using a half-wave plate, so that its polarization state is matched to the polarization state of the other component beam. By way of example, the polarization state of the second component beam can be rotated from an s-polarized component beam to a p-polarized component beam. However, it is understood that the component beams may also have a different defined polarization state. For example, the component beams can be or become elliptically polarized, more particularly circularly polarized.

The focusing element can preferably be an optical lens. According to one basic variant, a lens may be provided as a focusing element which focuses the first component beam and the second component beam at an end of the light-guiding element. However, it is understood that, according to an alternative variant, each of the component beams can also be focused into the light-guiding element by using a separate lens serving input coupling purposes. In such a case, it is not necessary for the two component beams to run parallel to one another. For input coupling into the light-guiding element, the component beams may also each be initially focused into a (short) connecting fiber, wherein the connecting fibers can be welded to the light-guiding element (e.g., likewise an optical fiber) by splicing. In such a case, the component beams reach the light-guiding element, where they are mixed to form the output laser beam, via the connecting fibers.

The light-guiding element may preferably have a circular cross section. Alternatively, the light-guiding element may also have a polygonal, for example rectangular, or elliptical cross section. By way of example, the light-guiding element can be an optical fiber, in particular a step-index fiber. However, other fiber types are also usable, for example a gradient-index fiber or a hollow-core fiber. The numerical aperture (NA) and the core diameter of the optical fiber play only a subordinate role for the effectiveness of the effects caused by the invention. For example, a light-guiding element according to the invention might be a step-index fiber with a core diameter of Ø=20 μm to Ø=400 μm, for example Ø=100 μm, and a numerical aperture of NA=0.065 to NA=0.22, for example NA=0.11. According to an alternative variant, the light-guiding element might also be a cylindrical or conical glass rod. The greater the numerical aperture of the fiber, the greater the angle with respect to the fiber longitudinal axis with which a component beam propagates through the fiber can be.

Further, the light-guiding element may have a tapering cross section. For example, the light-guiding element may be in the form of a conical optical fiber, specifically in the form of what is known as a tapered fiber. That is to say, the cross section of the fiber core reduces over the length of the fiber from the entrance end to the exit end (conical fiber). In comparison with an optical fiber which has an unchanging cross section (cylindrical fiber), the beam quality of the output laser beam can be improved using such a fiber. However, it should be observed that, in the case of the same length of the optical fiber, the retention of the polarization state may reduce with the reduction of the fiber diameter since the incident laser beams are reflected correspondingly more frequently within the optical fiber in the case of a reduced diameter.

With the objects of the invention in view, there is also provided a method for polarizing an input laser beam having an undefined polarization state according to a further aspect. In a first step, the method includes a splitting of the input laser beam into a first component beam having a first defined polarization state and into a second component beam having a second defined polarization state. In a second step, the method includes a changing of the polarization state of one of the polarized component beams, with the result that both component beams have the same defined polarization state. In a third step, the method includes an input coupling of both component beams into a light-guiding element in order to combine the component beams to form an output laser beam while maintaining the defined polarization state (of the component beams). It is understood that the method steps are performed in the sequence described.

For example, the method is able to be carried out by using an apparatus according to the invention in accordance with one of the above-described variants. In particular, the method may have one or more features and/or advantages of the above-described apparatus.

With the objects of the invention in view, there is concomitantly provided a laser machining system according to a further aspect. The laser machining system comprises a laser beam source for generating an input laser beam; a transportation optical fiber with a length of several meters, in particular more than 10 m, which is connected at a first of its ends to the laser beam source; and a machining optical unit which is connected to a second end of the transportation optical fiber. The machining optical unit includes: a collimation device for collimating the input laser beam incident in the machining optical unit from the transportation optical fiber; an apparatus according to any of the above-described variants for polarizing the input laser beam; and a focusing device for focusing the polarized output laser beam on an object to be machined.

For example, the laser machining system can be a laser cutting system for cutting preferably metallic workpieces.

The machining optical unit may further include a waveplate, in particular a half-wave plate, which is rotatably disposed in the beam path of the output laser beam, to be precise preferably between the polarization apparatus according to the invention and the focusing apparatus. By way of an appropriate rotation of the waveplate, the polarization direction of the output laser beam can be adapted to the cutting direction or advancement direction of the laser.

In summary, the above-described apparatus is based on the principle of a polarization-maintaining combination of at least two laser beams which, by using a focusing device, are input coupled into a light-guiding element which preferably has a length long enough to allow the at least two laser beams to be combined or mixed within the light-guiding element to form an output laser beam and/or short enough to maintain the polarization state of the at least two laser beams in the output laser beam.

Other features which are considered as characteristic for the invention are set forth in the appended claims.

Although the invention is illustrated and described herein as embodied in an apparatus and a method for polarizing a laser beam having an undefined polarization state and a laser machining system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1a-d show variants of an apparatus according to the invention for polarizing an input laser beam;

FIGS. 2a-b show variants of a light-guiding element according to the present invention;

FIG. 3 shows an alternative variant of a beam splitting device in comparison with the one depicted in FIGS. 1a-d;

FIG. 4a schematically shows a symmetric arrangement of a focusing element and a light-guiding element according to the present invention;

FIG. 4b schematically shows an asymmetric arrangement of a focusing element and a light-guiding element according to the present invention;

FIGS. 5a-d each show the beam profile of an output laser beam in the far field depending on the length of the light-guiding element, the beam profile being based on an arrangement according to FIG. 4a;

FIGS. 6a-d each show the beam profile of an output laser beam in the far field depending on the length of the light-guiding element, the beam profile being based on an arrangement according to FIG. 4b; and

FIG. 7 is a diagrammatic, perspective view of a laser cutting system according to the present invention.

### DETAILED DESCRIPTION OF THE INVENTION

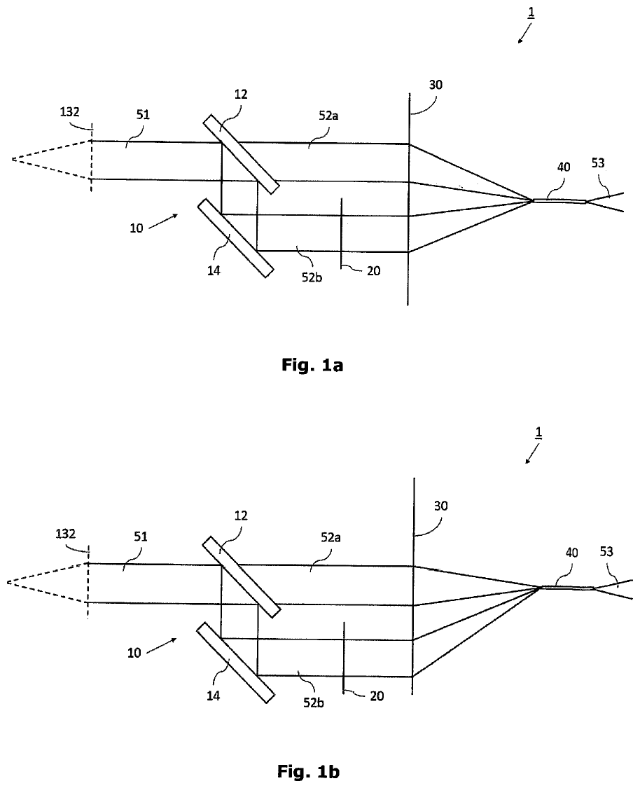

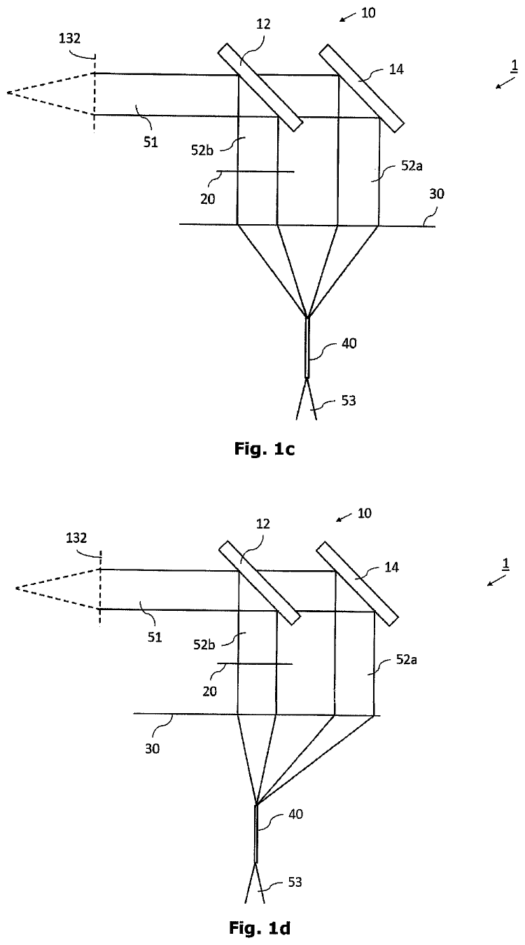

Variants of an apparatus according to the invention for polarizing an input laser beam are described in detail hereinafter in conjunction with FIGS. 1a-d, 2a-b, 3, and 4a-b.

Referring now to the figures of the drawings in detail and first, particularly, to FIG. 1a thereof, there is seen an apparatus 1 according to the invention for polarizing an input laser beam 51 in accordance with one variant. The input laser beam 51 has an undefined polarization state and is provided in a collimated state. To provide the collimated input laser beam, use can be made of a collimation device 132 in the form of a lens which is traversed by the input laser beam before the latter enters the apparatus 1.

The apparatus 1 according to FIG. 1a includes a beam splitter device 10 having a thin-film polarizer 12 and a mirror 14. Upon incidence of the input laser beam 51 on the thin-film polarizer 12, the input laser beam 51 is split into two differently polarized component beams 52a and 52b. To this end, the thin-film polarizer 12 is disposed at an angle in the beam path of the input laser beam 51. The first component beam 52a is transmitted by the thin-film polarizer 12 and the second component beam 52b is reflected upon incidence on the surface of the thin-film polarizer 12. The first component beam 52a transmitted through the thin-film polarizer 12 has a first defined polarization state (for example, p-polarization). The second component beam 52b reflected by the thin-film polarizer 12 has a second defined polarization state (for example, s-polarization). According to the illustration in FIG. 1a, the beam splitting device 10 also includes the mirror 14, which aligns the second component beam 52b, which is deflected by the thin-film polarizer 12, parallel to the first component beam 52a.

A waveplate 20, for example a half-wave plate, is also disposed in the beam path of the second component beam 52b and transforms the second polarization state of the second component beam 52b (for example, s-polarization) such that it corresponds to the first polarization state of the first component beam 52a (for example, p-polarization). That is to say, once the second component beam 52b has passed through the waveplate 20, both component beams 52a, 52b are parallel to one another and have the same defined polarization state (specifically the first polarization state, for example p-polarization).

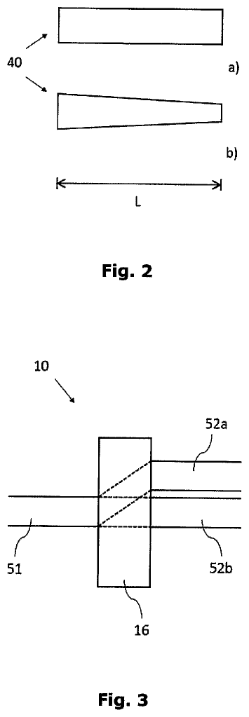

The apparatus 1 further includes a lens 30 which is disposed in the beam path of the two component beams 52a, 52b, in order to focus the latter and input couple these into a light-guiding element 40. The light-guiding element 40 has a length L (cf. FIGS. 2a and 2b) long enough to combine the two component beams 52a, 52b to form an output laser beam 53 within the light-guiding element 40 and short enough to maintain the polarization state of the two component beams 52a, 52b (e.g., p-polarization) in the output laser beam 53. By way of example, the light-guiding element 40 can be a step-index fiber with a length of between 20 mm and 50 mm.

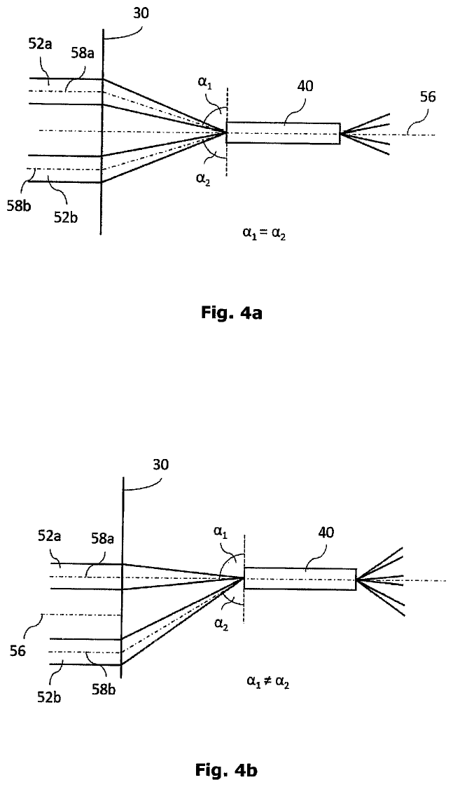

A variation of the apparatus 1 according to FIG. 1a is depicted in FIG. 1b. The apparatus according to FIG. 1b differs from the apparatus 1 depicted in FIG. 1a in terms of an asymmetric arrangement of the focusing element 30 and light-guiding element 40, in the case of which the component beams are input coupled into the light-guiding element at different angles. A more detailed description of the symmetric and asymmetric arrangement of the focusing element 30 and light-guiding element 40 is provided hereinbelow in the context of FIGS. 4a and 4b.

FIG. 1c shows an apparatus 1 according to the invention in accordance with a further variant, which differs from the variants according to FIGS. 1a and 1b in terms of the arrangement of the mirror 14 and the waveplate 20. Thus both the mirror 14 for aligning the two component beams 52a, 52b and the waveplate 20 are disposed in the first component beam 52a in accordance with FIG. 1c.

In a manner analogous to FIG. 1b, FIG. 1d depicts a variation of the apparatus 1 according to FIG. 1c, in the case of which the focusing element 30 and the light-guiding element 40 are disposed asymmetrically in the beam path of the component beams, with the result that the component beams are input coupled into the light-guiding element at different angles.

FIG. 2 schematically shows variants of a light-guiding element 40 that is usable in the apparatus 1 according to the invention, with the light-guiding element 40 being in the form of an optical fiber 40. Over its length L, the optical fiber 40 may have a constant cross section, for example a circular, elliptical, or polygonal cross section (see FIG. 2a). Alternatively, as what is known as a “tapered fiber,” the optical fiber 40 may have a cross section, for example a circular, elliptical, or polygonal cross section, which tapers over the length L (see FIG. 1b).

FIG. 3 schematically illustrates a variant of a beam splitting device 10 which differs from the arrangement according to FIGS. 1a-d. Thus the beam splitting device 10 according to FIG. 3 is constructed from a birefringent element 16 which has different refractive indices for different polarization states. When the incident input laser beam 51 is incident on the surface of the birefringent element 16, a first component beam 52a is deflected while a second component beam 52b enters the birefringent element 16 without deflection. Upon exit from the birefringent element, the component beams 52a, 52b are aligned due to refractive effects. Thus the birefringent element 16 fulfills both the function of the thin-film polarizer 12 and that of the mirror 14 (see FIGS. 1a-d). Equally, it should be observed that if a birefringent element 16 is used in an apparatus 1 according to the invention, then the spatial separation of the two component beams 52a, 52b depends on the thickness of the birefringent element 16 and is restricted thereby. The spatial separation of the component beams by using a birefringent element 16 becomes ever more difficult with increasing diameter of the input laser beam and with increasing laser power.

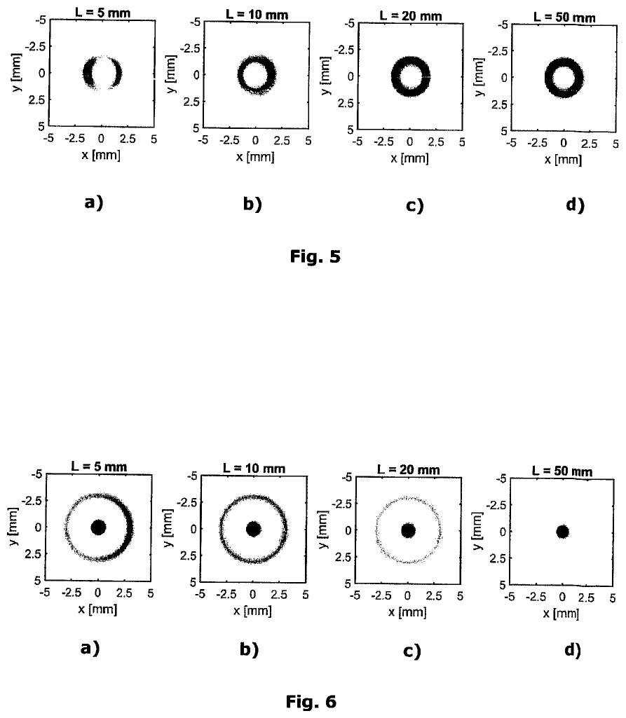

FIG. 4a depicts a symmetric arrangement of the focusing element in the form of a lens 30 and of the light-guiding element 40 in the beam path of the component beams 52a, 52b. Both component beams 52a, 52b are input coupled into the light-guiding element 40 at the same angle α1=α2 by positioning the lens 30 on a central axis 56 which runs centrally between the first component beam 52a and the second component beam 52b. A ring-shaped beam profile arises in the far field of the output laser beam 53 in this configuration (see FIGS. 5a-d).

As an alternative to the symmetric arrangement (see FIG. 4a), the lens 30 and the light-guiding element 40 may also be disposed asymmetrically in the beam path of the component beams 52a, 52b. Such a setup is depicted in FIG. 4b. The lens 30 and the light-guiding element 40 are disposed offset from the central axis 56. Specifically, the lens 30 and the light-guarding element 40 are disposed on a beam axis 58a of the first component beam 52a. In this way, the first component beam 52a is input coupled at right angles into the light-guiding element 40 at an optimal angle (α1=90°). By contrast, in comparison with the symmetric arrangement (see FIG. 4a), the second component beam is input coupled into the light-guiding element 40 at a more acute angle α2. The size of the angle α2 depends on the spacing of the component beams 52a, 52b from one another, and on the distance of the lens 30 from the light-guiding element 40. A beam profile according to FIGS. 6a-d arises in the far field of the output laser beam 53 as a result of the component beams 52a, 52b being input coupled into the light-guiding element 40 at different angles.

The illustration according to FIG. 4b shows a maximally asymmetric arrangement. It is understood that the lens 30 can be positioned as desired between the extreme positions on the beam axes 58a, 58b of the two component beams 52a, 52b in order to obtain intermediate states between the beam profiles depicted in FIGS. 5a-d and 6a-d.

FIGS. 5a-d and 6a-d depict the dependence of the symmetry of the output laser beam 53 on the length of the light-guiding element 40. FIGS. 5a to 5d show the beam profile of an output laser beam 53 in the far field in the case of an arrangement according to FIG. 4a, with the output laser beam 53 having been generated by using an apparatus according to the invention with light-guiding elements 40 of different length L. For the trial, a step-index fiber 40 with a core diameter of Ø=100 μm and a numerical aperture of NA=0.11 was used as light-guiding element 40. FIG. 5a corresponds to the use of an optical fiber 40 with a length of L=5 mm. FIGS. 5b, 5c, and 5d in turn correspond to a length L of the used optical fiber 40 of L=10 mm, L=20 mm and L=50 mm, respectively. It is evident that a radially symmetric beam profile does not yet form in the case of a length of L=5 mm or L=10 mm. By contrast, in the case of a length of L=20 mm or L=50 mm, the output laser beam 53 has a radially symmetric beam profile.

In a manner analogous to FIGS. 5a-d, FIGS. 6a-d depict the beam profile of an output laser beam 53 in the far field, for an arrangement according to FIG. 4b with in each case a different length L of the light-guiding element 40. The difference in relation to the illustrations according to FIGS. 5a-d resides in a beam profile with a central spot surrounded by a circle, which arises due to the asymmetric arrangement of the focusing element 30 and the light-guiding element 40 (cf. FIG. 4b). The configuration of the beam profile according to FIGS. 6a-d can be explained on the basis of the example depicted in FIG. 4b. The central spot results from the first component beam 52a, which was input coupled into the light-guiding element 40 at right angles. By contrast, the circular part of the beam profile is based on the second component beam 52b, which was input coupled into the light-guiding element 40 at a comparatively acute angle. Above a length of the light-guiding element 40 of L=10 mm, the outer ring already has good rotational symmetry in comparison with the symmetric arrangement (cf. FIG. 5b). This is due to the fact that the second component beam 52b is reflected more frequently within the light-guiding element 40 over the same length L of the light-guiding element 40 due to the angle of incidence which is more acute in comparison with the symmetric arrangement (cf. FIG. 4a).

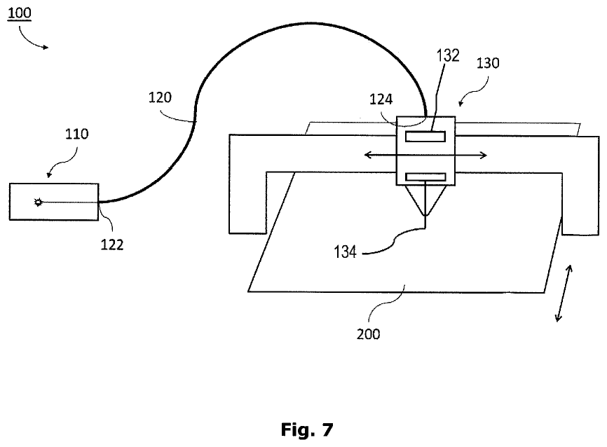

FIG. 7 diagrammatically illustrates a laser machining system 100 according to the present invention. The system 100 includes a laser beam source 110. The laser beam generated in the laser beam source 110 is guided by a transportation optical fiber 120, having a first end 122 and a second end 124, to a machining optical unit 130. An apparatus 1 according to the invention (not depicted in FIG. 7) is disposed in the machining optical unit 130 and used to polarize the unpolarized or randomly polarized input laser beam incident from the transportation optical fiber 120. The polarized output laser beam is directed by using a focusing device 134 at an object 200 to be machined, for example a planar, metallic workpiece, in order to machine the latter.

The following is a summary list of reference numerals and the corresponding structure used in the above description of the invention.

### LIST OF REFERENCE SIGNS

1 Apparatus for polarizing an input laser beam having an undefined polarization state
10 Beam splitting device
12 Thin-film polarizer
14 Mirror
16 Birefringent optical element
20 Polarization changing element
30 Focusing element
40 Light-guiding element
51 Input laser beam
52a First component beam
52b Second component beam
53 Output laser beam
56 Central axis in the beam path of the component beams
58a Beam axis of the first component beam
58b Beam axis of the second component beam
100 Laser cutting system
110 Laser beam source
120 Transportation optical fiber
122 First end of the transportation optical fiber
124 Second end of the transportation optical fiber
130 Machining optical unit
132 Collimation device
134 Focusing device
200 Object to be machined
L Length of the light-guiding element
α1 Input coupling angle of the first component beam into the light-guiding element
α2 Input coupling angle of the second component beam into the light-guiding element

1. An apparatus for polarizing an input laser beam having an undefined polarization state, the apparatus comprising:
a beam splitting device for splitting the input laser beam into a first component beam having a first defined polarization state and a second component beam having a second defined polarization state;
a polarization changing element for changing the polarization state of one of the polarized component beams, resulting in the first and second component beams having the same defined polarization state;
a focusing element; and
a light-guiding element;
said focusing element configured to input couple the first and second component beams into said light-guiding element in order to combine the first and second component beams to form an output laser beam while maintaining the defined polarization state.

2. The apparatus according to claim 1, wherein said beam splitting device is configured to deflect at least one of the first component beam or the second component beam, resulting in the first and second component beams running substantially parallel to one another.

3. The apparatus according to claim 1, wherein said light-guiding element has a length of no more than 500 mm.

4. The apparatus according to claim 1, wherein said light-guiding element has a length of no more than 100 mm.

5. The apparatus according to claim 1, wherein said light-guiding element has a length of no more than 50 mm.

6. The apparatus according to claim 1, wherein said light-guiding element has a length of at least 15 mm.

7. The apparatus according to claim 1, wherein said light-guiding element has a length of at least 20 mm.

8. The apparatus according to claim 1, wherein said focusing element and said light-guiding element are disposed symmetrically in a beam path of the component beams, to an extent that the component beams are input coupled into said light-guiding element at the same angle.

9. The apparatus according to claim 1, wherein said focusing element and said light-guiding element are disposed asymmetrically in a beam path of the component beams, to an extent that the component beams are input coupled into said light-guiding element at different angles.

10. The apparatus according to claim 1, wherein said focusing element and said light-guiding element are displaceably disposed at least one of along or across a beam propagation direction of the component beams.

11. The apparatus according to claim 1, wherein said beam splitting device includes:
a thin-film polarizer disposed at an angle in a beam path of the input laser beam causing a first component of the input laser beam, having the first defined polarization state, to be transmitted through said thin-film polarizer as the first component beam and causing a second component of the input laser beam, having the second defined polarization state, to be reflected at a surface of said thin-film polarizer as the second component beam; and
a mirror disposed at an angle in a beam path of one of the component beams to reflect an incident component beam and cause the incident component beam to be aligned substantially parallel to another component beam.

12. The apparatus according to claim 1, wherein said beam splitting device is a birefringent optical element having different refractive indices in relation to the first defined polarization state and the second defined polarization state, resulting in the input laser beam being split into the first component beam and the second component beam upon incidence in said birefringent element, and the component beams being aligned parallel to one another by refraction effects upon exiting from said birefringent element.

13. The apparatus according to claim 1, wherein said polarization changing element is a waveplate or a half-wave plate.

14. The apparatus according to claim 1, wherein said focusing element is an optical lens.

15. The apparatus according to claim 1, wherein said light-guiding element is a step-index fiber.

16. The apparatus according to claim 1, wherein said light-guiding element has a tapering cross section.

17. A method for polarizing an input laser beam having an undefined polarization state, the method comprising the steps of:
splitting the input laser beam into a first component beam having a first defined polarization state and a second component beam having a second defined polarization state;
changing the polarization state of one of the polarized component beams, resulting in the first and second component beams having the same defined polarization state; and
input coupling the first and second component beams into a light-guiding element in order to combine the first and second component beams to form an output laser beam while maintaining the defined polarization state.

18. A laser machining system, comprising:
a laser beam source for generating an input laser beam;
a transportation optical fiber having a length of several meters and having first and second ends, said first end being connected to said laser beam source; and
a machining optical unit connected to said second end of said transportation optical fiber, said machining optical unit including:
a collimation device for collimating the input laser beam incident in said machining optical unit from said transportation optical fiber;
an apparatus according to claim 1 for polarizing the input laser beam; and
a focusing device for focusing the polarized output laser beam onto an object to be machined.

19. The laser machining system according to claim 18, wherein said transportation optical fiber has a length of more than 10 m.
